(19) United States
(12) Patent Application Publication
(10) Pub. No.: US 2024/0317156 A1
(43) Pub. Date: Sep. 26, 2024

(54) WIRE HARNESS ROUTING STRUCTURE, LINK TYPE SLIDE DOOR, AND WIRE HARNESS

(71) Applicant: Yazaki Corporation, Tokyo (JP)

(72) Inventors: Naoto KOGURE, Shizuoka (JP); Hikaru SANO, Shizuoka (JP)

(73) Assignee: Yazaki Corporation, Tokyo (JP)

(21) Appl. No.: 18/735,415

(22) Filed: Jun. 6, 2024

Related U.S. Application Data
(63) Continuation of application No. PCT/JP2023/005915, filed on Feb. 20, 2023.

(30) Foreign Application Priority Data
Feb. 28, 2022 (JP) 2022-028836

(51) Int. Cl. B60R 16/02; B60J 5/06; E05D 15/06; E05D 15/10

(52) U.S. Cl. CPC B60R 16/0215; B60J 5/06; E05D 15/0621; E05D 2015/1076; E05Y 2400/654; E05Y 2900/531

(57) ABSTRACT

In a wire harness routing structure, a main link arm supports a door main body to be slidable with respect to a vehicle body while relatively rotating with respect to each of the vehicle body and the door main body. A sub-link arm supports the door main body to be slidable with respect to the vehicle body together with the main link arm while relatively rotating with respect to each of the vehicle body and the door main body. A first wiring line is provided to be routed along the main link arm, and connects a vehicle body-side connector on the vehicle body side and a door-side connector on the door main body side. A second wiring line is provided to be routed along the sub-link arm and connects the vehicle body-side connector on the vehicle body side and a second door-side connection target on the door main body side.

### CROSS-REFERENCE TO RELATED APPLICATION (S)

This application is a continuation application of International Application No. PCT/JP2023/005915 filed on Feb. 20, 2023 which claims the benefit of priority from Japanese Patent Application No. 2022-028836 filed on Feb. 28, 2022 and designating the U.S., the entire contents of which are incorporated herein by reference.

### BACKGROUND OF THE INVENTION

### 1. Field of the Invention

The present invention relates to a wire harness routing structure, a link type slide door, and a wire harness.

### 2. Description of the Related Art

Conventionally, for example, Japanese Patent Application Laid-open No. 2019-134626 describes a routing structure for a slide door. The routing structure for a slide door includes a slide door having a slide portion guided by a guide portion provided on a vehicle body side, a flexible conductor electrically connecting the slide door and the vehicle body side and traversing a trajectory space through which the slide portion passes, and a plate-shaped elastic body disposed along the conductor.

By the way, in a case where a link type slide door that does not include a slide portion but slides on the slide door by a link arm that fixes the slide door and a vehicle body is configured as the slide door, for example, in a case where a wire diameter of a wiring line connecting a device on the vehicle body side and a device on the slide door side is relatively large, it is difficult to bend the wiring line, and there is a possibility that wiring performance is deteriorated.

### SUMMARY OF THE INVENTION

Therefore, the present invention has been made in view of the above, and an object of the present invention is to provide a wire harness routing structure, a link type slide door, and a wire harness capable of appropriately routing a wiring line.

In order to achieve the above mentioned object, a wire harness routing structure according to one aspect of the present invention includes a first link arm that has one end rotatably coupled to a vehicle body and the other end rotatably coupled to a door main body and supports the door main body to be slidable with respect to the vehicle body while relatively rotating with respect to each of the vehicle body and the door main body; a second link arm that is provided side by side with the first link arm along a vertical direction, has one end rotatably coupled to the vehicle body and the other end rotatably coupled to the door main body, and supports the door main body to be slidable with respect to the vehicle body together with the first link arm while relatively rotating with respect to each of the vehicle body and the door main body; a first wiring line that is provided to be routed along the first link arm and connects a first vehicle body-side connection target on the vehicle body side and a first door-side connection target on the door main body side; and a second wiring line that is provided to be routed along the second link arm and connects a second vehicle body-side connection target on the vehicle body side and a second door-side connection target on the door main body side.

A link type slide door according to another aspect of the present invention includes a door main body that is assembled to a vehicle body; a first link arm that has one end rotatably coupled to the vehicle body and the other end rotatably coupled to the door main body and supports the door main body to be slidable with respect to the vehicle body while relatively rotating with respect to each of the vehicle body and the door main body; a second link arm that is provided side by side with the first link arm along a vertical direction, has one end rotatably coupled to the vehicle body and the other end rotatably coupled to the door main body, and supports the door main body to be slidable with respect to the vehicle body together with the first link arm while relatively rotating with respect to each of the vehicle body and the door main body; a first wiring line that is provided to be routed along the first link arm and connects a first vehicle body-side connection target on the vehicle body side and a first door-side connection target on the door main body side; and a second wiring line that is provided to be routed along the second link arm and connects a second vehicle body-side connection target on the vehicle body side and a second door-side connection target on the door main body side.

A wire harness according to still another aspect of the present invention includes a first wiring line that has one end rotatably coupled to a vehicle body and the other end rotatably coupled to a door main body assembled to the vehicle body, is provided to be routed along a first link arm that slidably supports the door main body with respect to the vehicle body while relatively rotating with respect to each of the vehicle body and the door main body, connects a first vehicle body-side connection target on the vehicle body side and a first door-side connection target on the door main body side; and a second wiring line that is provided side by side with the first link arm along a vertical direction, has one end rotatably coupled to the vehicle body and the other end rotatably coupled to the door main body, is provided to be routed along a second link arm that slidably supports the door main body with respect to the vehicle body together with the first link arm while relatively rotating with respect to each of the vehicle body and the door main body, and connects a second vehicle body-side connection target on the vehicle body side and a second door-side connection target on the door main body side.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration example of a wire harness routing structure according to an embodiment;

FIG. 2 is a perspective view illustrating a configuration example of a main link mechanism according to the embodiment; and

FIG. 3 is a perspective view illustrating a configuration example of a sub-link mechanism according to the embodiment.

### DETAILED DESCRIPTION OF THE PREFERRED EMBODIMENTS

A mode (embodiment) for carrying out the present invention will be described in detail with reference to the drawings. The present invention is not limited by the contents described in the following embodiment. In addition, constituent elements described below include those that can be easily assumed by those skilled in the art and those that are substantially the same. Furthermore, the configurations described below can be appropriately combined. In addition, various omissions, substitutions, or changes in the configuration can be made without departing from the gist of the present invention.

### Embodiment

A wire harness routing structure 1, a link type slide door SD, and a wire harness WH according to embodiments will be described with reference to the drawings.

In the following description, among a first direction, a second direction, and a third direction intersecting each other, the first direction is referred to as an “extension direction X”, the second direction is referred to as a “width direction Y”, and the third direction is referred to as a “height direction Z (intersecting direction Z)”. The extension direction X, the width direction Y, and the height direction Z intersect each other, and are typically orthogonal to each other. The extension direction X is, for example, a direction along a direction (longitudinal direction) in which a main link arm 11 to be described later extends. The width direction Y is, for example, a direction along a short direction of the main link arm 11. The height direction Z is a direction along a vehicle height direction (height direction of vehicle) of a vehicle, and is also a direction along the vertical direction. A sliding direction S of a door main body D is a direction along the extension direction X of the main link arm 11 in a state where the door main body D is closed, and corresponds to a direction along the entire length direction of the vehicle body B here. In other words, the sliding direction S of the door main body D is a direction intersecting a rotation axis (rotary shaft portions 12a and 13a to be described later) of the main link arm 11, and is typically a direction orthogonal to the rotation axis. Each direction used in the following description indicates a direction in a state in which each portion is assembled to each other unless otherwise specified.

The wire harness routing structure 1 is applied to a vehicle, supports the door main body D to be slidable with respect to the vehicle body B of the vehicle, and electrically connects a connection target such as a device or a connector provided on the vehicle body B side and a connection target such as a device or a connector provided on the door main body D side. In this example, a vehicle body-side connector BC1 as a first vehicle body-side connection target and a second vehicle body-side connection target is provided on the vehicle body B side, and a door-side connector DC1 as a first door-side connection target and a door-side connector DC2 as a second door-side connection target are provided on the door main body D side. The door-side connector DC1 is provided closer to a main link mechanism 10 to be described later than the door-side connector DC2, and the door-side connector DC2 is provided closer to a sub-link mechanism 20 to be described later than the door-side connector DC1. For example, the door-side connector DC1 is provided above the door-side connector DC2 in the height direction Z, and the door-side connector DC2 is provided below the door-side connector DC1 in the height direction z.

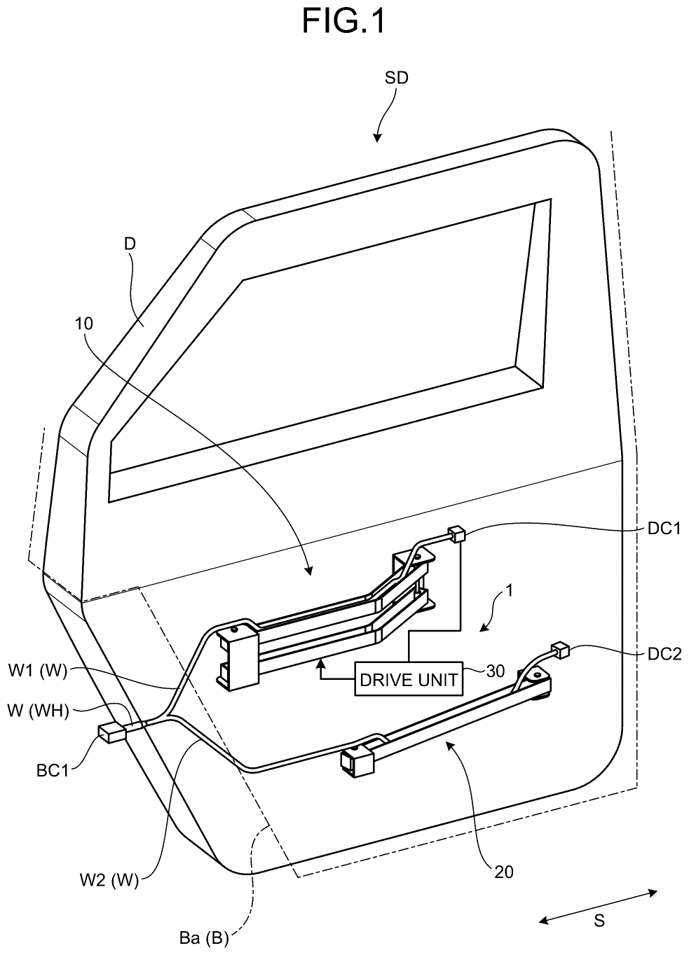

As illustrated in FIGS. 1 to 3, the wire harness routing structure 1 includes the main link mechanism 10, the sub-link mechanism 20, a drive unit 30, a first wiring line W1, and a second wiring line W2. The first wiring line W1 and the second wiring line W2 constitute a wire harness WH. In other words, it can also be said that the wire harness WH includes the first wiring line W1 and the second wiring line W2. The door main body D, the main link mechanism 10, the sub-link mechanism 20, the drive unit 30, the first wiring line W1, and the second wiring line W2 constitute a link type slide door SD. In other words, it can also be said that the link type slide door SD includes the door main body D, the main link mechanism 10, the sub-link mechanism 20, the drive unit 30, the first wiring line W1, and the second wiring line W2.

Here, in the wire harness routing structure 1, the door main body D is supported by the main link mechanism 10 and the sub-link mechanism 20, and the main link arm 11 and a sub-link arm 21 described later are rotated, so that the door main body D is slid and moved in the sliding direction S with respect to the vehicle body B without using a general sliding guide rail. Hereinafter, the wire harness routing structure 1 will be described in detail.

As illustrated in FIG. 1, the main link mechanism 10 is a mechanism that slidably supports the door main body D with respect to the vehicle body B together with the sub-link mechanism 20. In FIG. 1, the door opening Ba of the vehicle body B is indicated by a one-dot chain line. The main link mechanism 10 includes a main link arm 11, a first coupling portion 12, and a second coupling portion 13.

The main link arm 11 is a member that slidably supports the door main body D with respect to the vehicle body B. The main link arm 11 includes a first arm 11a and a second arm 11b.

The first arm 11a is a metal member extending along the extension direction X and formed in an elongated shape. For example, the first arm 11a is formed in a shape having a bent portion bent from the vehicle body B side to the door main body D side. Note that the first arm 11a is not limited to such a bent shape as long as the door main body D can be slidably supported with respect to the vehicle body B. The first arm 11a includes a bottom surface portion 11h and a pair of side wall portions 11i. The bottom surface portion 11h is a portion located on one side (lower side) in the height direction Z, and is formed in an elongated and flat plate shape along the extension direction X. Each of the pair of side wall portions 11i is formed in an elongated and flat plate shape along the extension direction X, is erected along the height direction Z from both ends in the width direction Y of the bottom surface portion 11h, and is positioned at a constant interval along the width direction Y. In the first arm 11a, the other side (upper side) in the height direction Z of the bottom surface portion 11h is opened, and both end portions in the extension direction X are closed. The first arm 11a configured as described above accommodates the first wiring line W1 routed between the vehicle body B side and the door main body D side in a groove portion 11d to be described later formed by being surrounded by the bottom surface portion 11h and the pair of side wall portions 11i.

The second arm 11b is configured similarly to the first arm 11a described above. That is, the second arm 11b is a metal member extending along the extension direction X and formed in an elongated shape. For example, the second arm 11b is formed in a shape having a bent portion bent from the vehicle body B side to the door main body D side. Note that the second arm 11b is not limited to such a bent shape as long as the door main body D can be slidably supported with respect to the vehicle body B. The second arm 11b is arranged side by side with the first arm 11a along the height direction Z. The second arm 11b includes a bottom surface portion 11m and a pair of side wall portions 11n. The bottom surface portion 11m is a portion located on one side (lower side) in the height direction z, and is formed in a long and flat plate shape along the extension direction X. Each of the pair of side wall portions 11n is formed in an elongated and flat plate shape along the extension direction X, is erected along the height direction Z from both ends in the width direction Y of the bottom surface portion 11m, and is positioned at a constant interval along the width direction Y. In the second arm 11b, the other side (upper side) in the height direction Z of the bottom surface portion 11m is opened, and both end portions in the extension direction X are closed. The second arm 11b configured as described above can accommodate the first wiring line W1 routed between the vehicle body B side and the door main body D side in a groove portion 11e described later formed by being surrounded by the bottom surface portion 11m and the pair of side wall portions 11n.

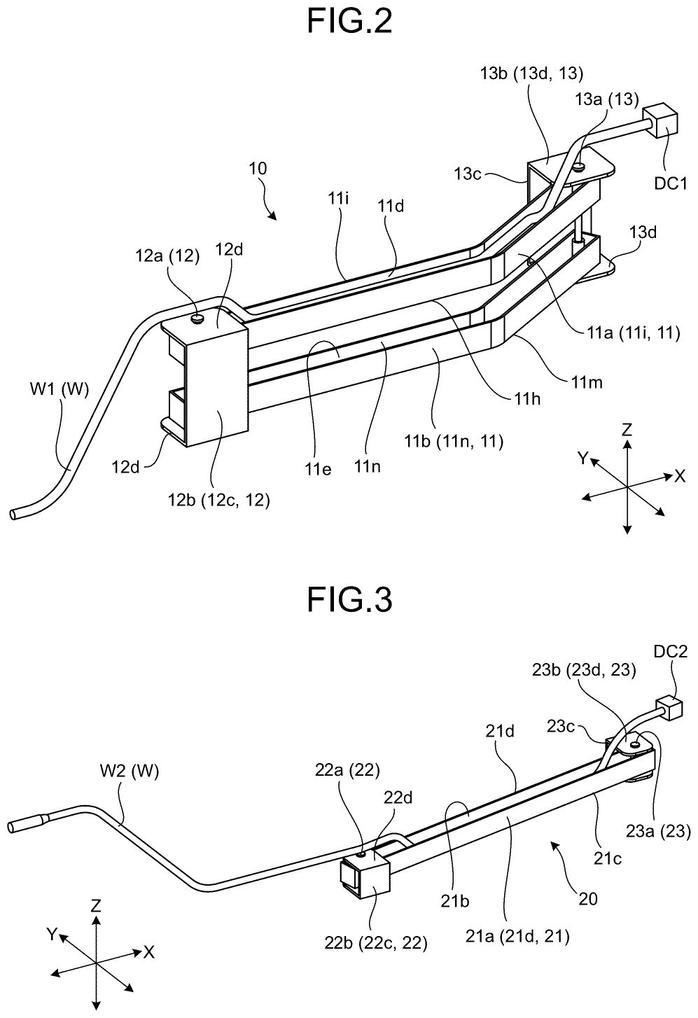

Next, the first coupling portion 12 will be described. As illustrated in FIG. 2, the first coupling portion 12 rotatably couples one end of the main link arm 11 in the extension direction X to the vehicle body B, and includes a rotary shaft portion 12a and a bearing portion 12b.

The rotary shaft portion 12a rotatably supports one end of the main link arm 11 in the extension direction X. The rotary shaft portion 12a is formed in a rod shape, extends along the height direction Z, and is inserted through a hole portion (cylindrical hole portion) at one end in the extension direction X of the main link arm 11. Specifically, in the main link arm 11, the rotary shaft portion 12a is inserted through a hole portion at one end of the first arm 11a in the extension direction X and a hole portion at one end of the second arm 11b in the extension direction X. The rotary shaft portion 12a is provided with a stopper (not illustrated) for keeping the interval between the first arm 11a and the second arm 11b constant in the height direction Z. The stopper prevents the first arm 11a and the second arm 11b from being displaced in the height direction Z. The rotary shaft portion 12a extending along the height direction Z supports one end of the first arm 11a and one end of the second arm 11b to be rotatable about an axis of the rotary shaft portion 12a. Note that the configuration for preventing the first arm 11a and the second arm 11b from being displaced may be a configuration other than the stopper.

The bearing portion 12b couples the rotary shaft portion 12a to the vehicle body B. The bearing portion 12b includes a fixing plate 12c and a pair of support plates 12d.

The fixing plate 12c is a portion fixed to the vehicle body B. The fixing plate 12c is formed in a flat plate shape, extends along the height direction Z, and is fixed to the vehicle body B.

The pair of support plates 12d supports the rotary shaft portion 12a. Each of the pair of support plates 12d is formed in a flat plate shape, is erected along the width direction Y from both ends of the fixing plate 12c in the height direction Z, and is positioned at a constant interval along the height direction Z. The pair of support plates 12d is provided with a rotary shaft portion 12a between one support plate 12d and the other support plate 12d. Each of the pair of support plates 12d has a hole portion through which the rotary shaft portion 12a is inserted, one end of the rotary shaft portion 12a is inserted through the hole portion of one support plate 12d, and the other end of the rotary shaft portion 12a is inserted through the hole portion of the other support plate 12d. Retaining portions are provided at both end portions of the rotary shaft portion 12a inserted through the pair of support plates 12d. In the bearing portion 12b configured as described above, the fixing plate 12c is fixed to the vehicle body B in a state where both ends of the rotary shaft portion 12a inserted through the first arm 11a and the second arm 11b are supported by the pair of support plates 12d.

Next, the second coupling portion 13 will be described. As illustrated in FIG. 2, the second coupling portion 13 rotatably couples the other end of the main link arm 11 in the extension direction X to the door main body D, and is configured similarly to the first coupling portion 12. That is, the second coupling portion 13 includes a rotary shaft portion 13a and a bearing portion 13b.

The rotary shaft portion 13a rotatably supports the other end of the main link arm 11 in the extension direction X. The rotary shaft portion 13a is formed in a rod shape, extends along the height direction Z, and is inserted through a hole portion (cylindrical hole portion) at the other end in the extension direction X of the main link arm 11. Specifically, in the main link arm 11, the rotary shaft portion 13a is inserted through a hole portion at the other end of the first arm 11a in the extension direction X and a hole portion at the other end of the second arm 11b in the extension direction X. The rotary shaft portion 13a is provided with a stopper (not illustrated) for keeping the interval between the first arm 11a and the second arm 11b constant in the height direction Z. The stopper prevents the first arm 11a and the second arm 11b from being displaced in the height direction Z. The rotary shaft portion 13a extending along the height direction Z supports the other end of the first arm 11a and the other end of the second arm 11b to be rotatable about the axis of the rotary shaft portion 13a. Note that the configuration for preventing the first arm 11a and the second arm 11b from being displaced may be a configuration other than the stopper.

The bearing portion 13b couples the rotary shaft portion 13a to the door main body D. The bearing portion 13b includes a fixing plate 13c and a pair of support plates 13d.

The fixing plate 13c is a portion fixed to the door main body D. The fixing plate 13c is formed in a flat plate shape, extends along the height direction Z, and is fixed to the door main body D.

The pair of support plates 13d supports the rotary shaft portion 13a. Each of the pair of support plates 13d is formed in a flat plate shape, is erected along the width direction Y from both ends of the fixing plate 13c in the height direction Z, and is positioned at a constant interval along the height direction Z. The pair of support plates 13d is provided with the rotary shaft portion 13a between one support plate 13d and the other support plate 13d. Each of the pair of support plates 13d has a hole portion through which the rotary shaft portion 13a is inserted, one end of the rotary shaft portion 13a is inserted through the hole portion of one support plate 13d, and the other end of the rotary shaft portion 13a is inserted through the hole portion of the other support plate 13d. Retaining portions are provided at both end portions of the rotary shaft portion 13a inserted through the pair of support plates 13d. In the bearing portion 13b configured as described above, the fixing plate 13c is fixed to the door main body D in a state where both ends of the rotary shaft portion 13a inserted through the first arm 11a and the second arm 11b are supported by the pair of support plates 13d.

The main link arm 11 configured as described above supports the door main body D to be slidable along the sliding direction S with respect to the vehicle body B together with the sub-link mechanism 20 while relatively rotating with respect to each of the vehicle body B and the door main body D.

Next, the sub-link mechanism 20 will be described. The sub-link mechanism is provided side by side with the main link mechanism 10 along the height direction Z. In this example, the sub-link mechanism 20 is provided on the lower side of the main link mechanism 10 in the height direction Z, and supports the door main body D to be slidable with respect to the vehicle body B together with the main link mechanism 10. The sub-link mechanism 20 includes a sub-link arm 21, a first coupling portion 22, and a second coupling portion 23.

The sub-link arm 21 is provided side by side with the main link arm 11 along the height direction Z, and includes a first arm 21a as illustrated in FIG. 3.

The first arm 21a is a metal member extending along the extension direction X and formed in an elongated shape. The first arm 21a is formed linearly along the extension direction X, for example. Note that the first arm 21a is not limited to such a linear shape as long as the door main body D can be slidably supported with respect to the vehicle body B. The first arm 21a includes a bottom surface portion 21c and a pair of side wall portions 21d. The bottom surface portion 21c is a portion located on one side (lower side) in the height direction Z, and is formed in a long and flat plate shape along the extension direction X. Each of the pair of side wall portions 21d is formed in an elongated and flat plate shape along the extension direction X, is erected along the height direction Z from both ends in the width direction Y of the bottom surface portion 21c, and is positioned at a constant interval along the width direction Y. In the first arm 21a, the other side (upper side) in the height direction Z of the bottom surface portion 21c is opened, and both end portions in the extension direction X are closed. The first arm 21a configured as described above accommodates the second wiring line W2 routed between the vehicle body B side and the door main body D side in a groove portion 21b to be described later formed by being surrounded by the bottom surface portion 21c and the pair of side wall portions 21d.

Next, the first coupling portion 22 will be described. As illustrated in FIG. 3, the first coupling portion 22 rotatably couples one end of the sub-link arm 21 in the extension direction X to the vehicle body B, and includes a rotary shaft portion 22a and a bearing portion 22b.

The rotary shaft portion 22a rotatably supports one end of the sub-link arm 21 in the extension direction X. The rotary shaft portion 22a is formed in a rod shape, extends along the height direction Z, and is inserted through a hole portion (cylindrical hole portion) at one end of the sub-link arm 21 in the extension direction X. Specifically, the rotary shaft portion 22a is inserted through a hole portion at one end of the first arm 21a in the extension direction X in the sub-link arm 21. The rotary shaft portion 22a extending along the height direction Z supports one end of the first arm 21a to be rotatable about an axis of the rotary shaft portion 22a.

The bearing portion 22b couples the rotary shaft portion 22a to the vehicle body B. The bearing portion 22b includes a fixing plate 22c and a pair of support plates 22d.

The fixing plate 22c is a portion fixed to the vehicle body B. The fixing plate 22c is formed in a flat plate shape, extends along the height direction Z, and is fixed to the vehicle body B.

The pair of support plates 22d supports the rotary shaft portion 22a. Each of the pair of support plates 22d is formed in a flat plate shape, is erected along the width direction Y from both ends of the fixing plate 22c in the height direction Z, and is positioned at a constant interval along the height direction Z. The pair of support plates 22d is provided with a rotary shaft portion 22a between one support plate 22d and the other support plate 22d. Each of the pair of support plates 22d has a hole portion through which the rotary shaft portion 22a is inserted, one end of the rotary shaft portion 22a is inserted through the hole portion of one support plate 22d, and the other end of the rotary shaft portion 22a is inserted through the hole portion of the other support plate 22d. Retaining portions are provided at both end portions of the rotary shaft portion 22a inserted through the pair of support plates 22d. In the bearing portion 22b configured as described above, the fixing plate 22c is fixed to the vehicle body B in a state where both ends of the rotary shaft portion 22a inserted through the first arm 21a are supported by the pair of support plates 22d.

Next, the second coupling portion 23 will be described. As illustrated in FIG. 3, the second coupling portion 23 rotatably couples the other end of the sub-link arm 21 in the extension direction X to the door main body D, and is configured similarly to the first coupling portion 22. That is, the second coupling portion 23 includes a rotary shaft portion 23a and a bearing portion 23b.

The rotary shaft portion 23a rotatably supports the other end of the sub-link arm 21 in the extension direction X. The rotary shaft portion 23a is formed in a rod shape, extends along the height direction Z, and is inserted through a hole portion (cylindrical hole portion) at the other end of the sub-link arm 21 in the extension direction X. Specifically, in the sub-link arm 21, the rotary shaft portion 23a is inserted through a hole portion at the other end of the first arm 21a in the extension direction X. The rotary shaft portion 23a extending along the height direction Z supports the other end of the first arm 21a to be rotatable about an axis of the rotary shaft portion 23a.

The bearing portion 23b couples the rotary shaft portion 23a to the door main body D. The bearing portion 23b includes a fixing plate 23c and a pair of support plates 23d.

The fixing plate 23c is a portion fixed to the door main body D. The fixing plate 23c is formed in a flat plate shape, extends along the height direction Z, and is fixed to the door main body D.

The pair of support plates 23d supports the rotary shaft portion 23a. Each of the pair of support plates 23d is formed in a flat plate shape, is erected along the width direction Y from both ends of the fixing plate 23c in the height direction Z, and is positioned at a constant interval along the height direction Z. The pair of support plates 23d is provided with the rotary shaft portion 23a between one support plate 23d and the other support plate 23d. Each of the pair of support plates 23d has a hole portion through which the rotary shaft portion 23a is inserted, one end of the rotary shaft portion 23a is inserted through the hole portion of one support plate 23d, and the other end of the rotary shaft portion 23a is inserted through the hole portion of the other support plate 23d. Retaining portions are provided at both end portions of the rotary shaft portion 23a inserted through the pair of support plates 23d. In the bearing portion 23b configured as described above, the fixing plate 23c is fixed to the door main body D in a state where both ends of the rotary shaft portion 23a inserted through the first arm 21a are supported by the pair of support plates 23d.

The sub-link arm 21 configured as described above supports the door main body D to be slidable with respect to the vehicle body B together with the main link arm 11 while relatively rotating with respect to each of the vehicle body B and the door main body D.

Next, the drive unit 30 will be described. The drive unit 30 rotates the main link arm 11, and includes a motor and the like. The drive unit 30 is provided, for example, in the door main body D, and is connected to the first wiring line W1 via the door-side connector DC1. The drive unit 30 is operated by the power supplied via the first wiring line W1 to rotate the main link arm 11. The drive unit 30 is coupled to a rotary shaft of the main link arm 11 via, for example, a drive shaft, a gear, or the like that transmits rotational force, and rotates the rotary shaft to rotate the main link arm 11.

The wire harness routing structure 1 includes the groove portions 11d and 11e provided in the main link arm 11 and the groove portion 21b provided in the sub-link arm 21 as a structure for routing the wiring line W to the link type slide door SD as described above.

The groove portion 11d is provided in the first arm 11a of the main link arm 11, and is a region formed by being surrounded by the bottom surface portion 11h and the pair of side wall portions 11i of the first arm 11a. The groove portion 11d is formed in a groove shape along the extension direction X in the first arm 11a, and a cross section of the groove portion 11d is formed in a rectangular shape. The groove portion 11d has an accommodation space portion capable of accommodating the wiring line W, and can accommodate the wiring line W routed along the first arm 11a between the vehicle body B side and the door main body D side in the accommodation space portion. In this example, an example is illustrated in which the wiring line W (first wiring line W1) is actually accommodated in the accommodation space portion.

The groove portion 11e is provided in the second arm 11b of the main link arm 11, and is a region formed by being surrounded by the bottom surface portion 11m and the pair of side wall portions 11n of the second arm 11b. The groove portion 11e is formed in a groove shape along the extension direction X in the second arm 11b, and a cross section of the groove portion 11e is formed in a rectangular shape. The groove portion 11e has an accommodation space portion capable of accommodating the wiring line W, and can accommodate the wiring line W routed along the second arm 11b between the vehicle body B side and the door main body D side in the accommodation space portion. In this example, an example in which the wiring line W is not accommodated in the accommodation space portion is illustrated.

The groove portion 21b is provided in the first arm 21a of the sub-link arm 21, and is a region formed by being surrounded by the bottom surface portion 21c and the pair of side wall portions 21d of the first arm 21a. The groove portion 21b is formed in a groove shape along the extension direction X in the first arm 21a, and a cross section of the groove portion 21b is formed in a rectangular shape. The groove portion 21b has an accommodation space portion capable of accommodating the wiring line W, can accommodate the wiring line W routed along the first arm 21a between the vehicle body B side and the door main body D side in the accommodation space portion, and accommodates the wiring line W (second wiring line W2) in the accommodation space portion.

Next, the first wiring line W1 routed in the groove portion 11d of the main link arm 11 will be described. The first wiring line W1 includes a power line for supplying power, a communication line for performing communication, and the like. The first wiring line W1 is one wiring line branched on the vehicle body B side from one bundle of wiring lines W connected to the common vehicle body-side connector BC1. The first wiring line W1 is arranged and provided along the main link arm 11, and is routed in a state of being accommodated in the groove portion 11d of the main link arm 11 in this example. The first wiring line W1 accommodated in the groove portion 11d of the main link arm 11 connects the vehicle body-side connector BC1 provided on the vehicle body B side and the door-side connector DC1 provided on the door main body D side. In the first wiring line W1, a line length connecting the vehicle body-side connector BC1 and the door-side connector DC1 along the main link arm 11 is shorter than a length of a line connecting the vehicle body-side connector BC1 and the door-side connector DC1 via the sub-link arm 21. In this manner, the first wiring line W1 is routed along the shortest connection path when the vehicle body-side connector BC1 and the door-side connector DC1 are connected.

Next, the second wiring line W2 routed in the groove portion 21b of the sub-link arm 21 will be described. The second wiring line W2 includes a power line for supplying power, a communication line for performing communication, and the like. The second wiring line W2 is the other wiring line branched on the vehicle body B side from one bundle of the wiring lines W connected to the common vehicle body-side connector BC1. The second wiring line W2 is provided to be routed along the sub-link arm 21, and is routed in a state of being accommodated in the groove portion 21b of the sub-link arm 21 in this example. The second wiring line W2 accommodated in the groove portion 21b of the sub-link arm 21 connects the vehicle body-side connector BC1 provided on the vehicle body B side and the door-side connector DC2 provided on the door main body D side. In the second wiring line W2, a line length connecting the vehicle body-side connector BC1 and the door-side connector DC2 along the sub-link arm 21 is shorter than a length of a line connecting the vehicle body-side connector BC1 and the door-side connector DC2 via the main link arm 11. As described above, the second wiring line W2 is routed along the shortest connection path when the vehicle body-side connector BC1 and the door-side connector DC2 are connected.

In the wire harness routing structure 1 configured as described above, when the main link arm 11 is rotated by the drive unit 30, the main link arm 11 and the sub-link arm 21 are relatively rotated with respect to each of the vehicle body B and the door main body D, and the door main body D is slidingly moved along the sliding direction S from a fully closed position to a fully open position or from the fully open position to the fully closed position with respect to the vehicle body B. That is, the main link arm 11 is relatively rotated with respect to each of the vehicle body B and the door main body D with the rotary shaft portion 12a of the first coupling portion 12 and the rotary shaft portion 13a of the second coupling portion 13 as rotary shafts by being rotated by the drive unit 30. At this time, when the main link arm 11 is rotated by the drive unit 30, the sub-link arm 21 relatively rotates with respect to each of the vehicle body B and the door main body D using the rotary shaft portion 22a of the first coupling portion 22 and the rotary shaft portion 23a of the second coupling portion 23 as rotary shafts. The first wiring line W1 routed along the main link arm 11 and accommodated in the groove portion 11d electrically connects the vehicle body-side connector BC1 and the door-side connector DC1 even while the main link arm 11 rotates. In addition, the second wiring line W2 routed along the sub-link arm 21 and accommodated in the groove portion 21b electrically connects the vehicle body-side connector BC1 and the door-side connector DC2 while the sub-link arm 21 rotates.

As described above, the wire harness routing structure 1 according to the embodiment includes the main link arm 11, the sub-link arm 21, the first wiring line W1, and the second wiring line W2. The main link arm 11 has one end rotatably coupled to the vehicle body B and the other end rotatably coupled to the door main body D, and slidably supports the door main body D with respect to the vehicle body B while relatively rotating with respect to each of the vehicle body B and the door main body D. The sub-link arm 21 is provided side by side with the main link arm 11 along the height direction Z, has one end rotatably coupled to the vehicle body B and the other end rotatably coupled to the door main body D, and slidably supports the door main body D with respect to the vehicle body B together with the main link arm 11 while relatively rotating with respect to each of the vehicle body B and the door main body D. The first wiring line W1 is provided to be routed along the main link arm 11, and connects the vehicle body-side connector BC1 on the vehicle body B side and the door-side connector DC1 on the door main body D side. The second wiring line W2 is provided to be routed along the sub-link arm 21, and connects the vehicle body-side connector BC1 on the vehicle body B side and the door-side connector DC2 on the door main body D side.

With this configuration, in the wire harness routing structure 1, the wiring line W routed between the vehicle body B and the door main body D is routed while being divided into the first wiring line W1 and the second wiring line W2, so that the wire diameter of each wiring line can be relatively reduced, whereby the flexibility can be secured. Since the wire harness routing structure 1 can ensure the flexibility of the first and second wiring lines W1 and W2, it is possible to suppress a decrease in durability of the first and second wiring lines W1 and W2. In addition, since the wire diameter of the first and second wiring lines W1 and W2 can be reduced in the wire harness routing structure 1, the routing space in the vicinity of the main link arm 11 and the routing space in the vicinity of the sub-link arm 21 can be relatively reduced, the design components of the arms 11 and 12 can be reduced, and the appearance can be improved. As described above, the wire harness routing structure 1 can appropriately route the wiring line W.

In the wire harness routing structure 1, the first vehicle body-side connection target and the second vehicle body-side connection target are the common vehicle body-side connector BC1, and the first wiring line W1 is one wiring line branched on the vehicle body B side from one bundle of wiring lines W connected to the common vehicle body-side connector BC1. The second wiring line W2 is the other wiring line branched from one bundle of the wiring lines W on the vehicle body B side. Unlike the related art, with this configuration, the wire harness routing structure 1 can reduce the wire diameters of the first and second wiring lines W1 and W2 routed on the door main body D side as compared with a case where one bundle of the wiring lines W connected to the vehicle body-side connector BC1 is routed on the door main body D side in a state of one bundle of the wiring lines W as it is, so that the wiring lines W can be appropriately routed.

In the wire harness routing structure 1, a line length of the first wiring line W1 connecting the vehicle body-side connector BC1 and the door-side connector DC1 along the main link arm 11 is shorter than a length of a path connecting the vehicle body-side connector BC1 and the door-side connector DC1 via the sub-link arm 21. In the second wiring line W2, a line length connecting the vehicle body-side connector BC1 and the door-side connector DC2 along the sub-link arm 21 is shorter than a length of a path connecting the vehicle body-side connector BC1 and the door-side connector DC2 via the main link arm 11. With this configuration, in the wire harness routing structure 1, the vehicle body-side connector BC1 and the door-side connector DC1 can be connected by the first wiring line W1 at the shortest distance, and the vehicle body-side connector BC1 and the door-side connector DC2 can be connected by the second wiring line W2 at the shortest distance.

The wire harness routing structure 1 includes a drive unit 30 that is provided in the door main body D and rotates the main link arm 11. The first wiring line W1 includes a power line for supplying power to the drive unit 30. With this configuration, the wire harness routing structure 1 can rotate the main link arm 11 by operating the drive unit 30 with the power supplied via the first wiring line W1.

The link type slide door SD includes the door main body D assembled to the vehicle body B, the main link arm 11, the sub-link arm 21, the first wiring line W1, and the second wiring line W2. The first wiring line W1 is provided to be routed along the main link arm 11, and connects the vehicle body-side connector BC1 on the vehicle body B side and the door-side connector DC1 on the door main body D side. The second wiring line W2 is provided to be routed along the sub-link arm 21, and connects the vehicle body-side connector BC1 on the vehicle body B side and the door-side connector DC2 on the door main body D side. With this configuration, in the link type slide door SD, the wiring line W routed between the vehicle body B and the door main body D is divided into the first wiring line W1 and the second wiring line W2 and routed, so that the wire diameters of the respective wiring lines W1 and W2 can be relatively reduced, whereby the flexibility can be secured. As a result, the wiring line W can be appropriately routed.

The wire harness WH includes the first wiring line W1 provided to be routed along the main link arm 11 and connecting the vehicle body-side connector BC1 on the vehicle body B side and the door-side connector DC1 on the door main body D side, and the second wiring line W2 provided to be routed along the sub-link arm 21 and connecting the vehicle body-side connector BC1 on the vehicle body B side and the door-side connector DC2 on the door main body D side. With this configuration, in the wire harness WH, the wiring line W routed between the vehicle body B and the door main body D is routed separately into the first wiring line W1 and the second wiring line W2, so that the wire diameters of the respective wiring lines W1 and W2 can be relatively reduced, whereby the flexibility can be secured, and as a result, the wiring line W can be appropriately routed.

### Modification

The example in which the first vehicle body-side connection target and the second vehicle body-side connection target are the common vehicle body-side connector BC1 has been described, but the present invention is not limited thereto. For example, the first vehicle body-side connection target and the second vehicle body-side connection target may be different vehicle body-side connectors.

The first door-side connection target and the second door-side connection target are different door-side connectors DC1 and DC2, respectively. However, the present invention is not limited to this. For example, the first door-side connection target and the second door-side connection target may be common door-side connectors.

The first and second wiring lines W1 and W2 have been described as an example in which one bundle of wiring lines W is the wiring line branched on the vehicle body B side, but the present invention is not limited thereto. For example, the first and second wiring lines W1 and W2 may not be a wiring line in which one bundle of wiring lines W is branched on the vehicle body B side, but may be a wiring line in which two bundles of wiring lines W are separately routed in parallel (parallel) from the vehicle body B side. Further, the first and second wiring lines W1 and W2 may merge (join) on the door main body D side to be connected to a common door-side connector.

Although the example in which the first and second wiring lines W1 and W2 are routed at the shortest distance has been described, the present invention is not limited thereto, and the first and second wiring lines W1 and W2 may not be routed at the shortest distance.

In the wire harness routing structure 1, an example in which the main link arm 11 is rotated by the drive unit 30 so that the main link arm 11 and the sub-link arm 21 rotate relative to each of the vehicle body B and the door main body D has been described, but the present invention is not limited thereto. For example, the main link arm 11 and the sub-link arm 21 may rotate relative to each of the vehicle body B and the door main body D by a sliding operation of the door main body D by an occupant of the vehicle without including the drive unit 30.

Although the example in which the drive unit 30 is provided in the door main body D has been described, the invention is not limited thereto, and for example, the drive unit may be provided in the main link arm 11. The drive unit 30 provided in the main link arm 11 is connected to the first wiring line W1 and operated by power supplied via the first wiring line W1 to rotate the main link arm 11. The drive unit 30 is coupled to a rotary shaft of the main link arm 11 via, for example, a drive shaft, a gear, or the like that transmits rotational force, and rotates the rotary shaft to rotate the main link arm 11.

Although the example in which the groove portions 11d, 11e, and 21b are formed in a rectangular cross section has been described, the present invention is not limited thereto, and for example, the cross section may be formed in a U-shape, a C-shape, an H-shape, or the like in which the bottom surface is curved.

In the groove portion 11d, an example in which the bottom surface portion 11h is located on one side (lower side) in the height direction Z, and the other side (upper side) in the height direction Z of the bottom surface portion 11h is opened has been described. However, the present invention is not limited to this. For example, the bottom surface portion 11h may be located on one side in the width direction Y, and the other side in the width direction Y of the bottom surface portion 11h may be opened. In this case, the pair of side wall portions 11i is provided on both sides in the height direction Z. As for the groove portions 11e and 21b, similarly, the bottom surface portions 11m and 21c may be positioned on one side in the width direction Y, and the other side in the width direction Y of the bottom surface portions 11m and 21c may be opened. In this case, the pair of side wall portions 11n and 21d is provided on both sides in the height direction Z.

Although the example in which the main link arm 11 rotates with the rotary shaft portions 12a and 13a at both ends as the rotary shafts in one arm member has been described, the present invention is not limited thereto. For example, the main link arm may be divided in the extension direction X, and the divided arms may be connected by links. In this case, a groove portion may be formed in each divided arm, each groove portion may be continuous across each divided arm, and the first wiring line W1 may be routed in the continuous groove portion across each divided arm.

The example in which the sub-link arm 21 rotates with the rotary shaft portions 22a and 23a at both ends as the rotary shaft in one arm member has been described, but the present invention is not limited thereto. For example, the sub-link arm may be divided in the extension direction X, and the divided arms may be connected by links. In this case, a groove portion may be formed in each divided arm, each groove portion may be continuous across each divided arm, and the second wiring line W2 may be routed in the continuous groove portion across each divided arm.

An example in which the main link mechanism 10 routes the wiring line W to the first arm 21a and does not route the wiring line W to the second arm 11b has been described, but the present invention is not limited thereto, and the wiring line W may also be routed to the second arm 11b.

Although the example in which the main link arm 11 includes the groove portions 11d and 11e has been described, the present invention is not limited thereto, and the main link arm may not include the groove portions 11d and 11e. In this case, the main link arm 11 is formed in, for example, a tubular shape, a rod shape (columnar shape), or the like, and when formed in the tubular shape, the first wiring line W1 is inserted and routed inside, and when formed in the rod shape (columnar shape), the first wiring line W1 is routed side by side with the arm.

Although the example in which the sub-link arm 21 includes the groove portion 21b has been described, the present invention is not limited thereto, and the sub-link arm may not include the groove portion 21b. In this case, the sub-link arm 21 is formed in, for example, a tubular shape, a rod shape (columnar shape), or the like, and when formed in the tubular shape, the second wiring line W2 is inserted and routed inside, and when formed in the rod shape (columnar shape), the second wiring line W2 is routed side by side with the arm.

In the wire harness routing structure, the link type slide door, and the wire harness according to the present embodiment, the wiring lines routed between the vehicle body and the door main body are routed while being divided into the first wiring line and the second wiring line. Therefore, the wire diameters of the respective wiring lines can be relatively reduced, flexibility can be secured, and thus, the wiring lines can be appropriately routed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness routing structure comprising:
a first link arm that has one end rotatably coupled to a vehicle body and the other end rotatably coupled to a door main body and supports the door main body to be slidable with respect to the vehicle body while relatively rotating with respect to each of the vehicle body and the door main body;
a second link arm that is provided side by side with the first link arm along a vertical direction, has one end rotatably coupled to the vehicle body and the other end rotatably coupled to the door main body, and supports the door main body to be slidable with respect to the vehicle body together with the first link arm while relatively rotating with respect to each of the vehicle body and the door main body;
a first wiring line that is provided to be routed along the first link arm and connects a first vehicle body-side connection target on the vehicle body side and a first door-side connection target on the door main body side; and
a second wiring line that is provided to be routed along the second link arm and connects a second vehicle body-side connection target on the vehicle body side and a second door-side connection target on the door main body side.

2. The wire harness routing structure according to claim 1, wherein
the first vehicle body-side connection target and the second vehicle body-side connection target are common connection targets,
the first wiring line is one wiring line branched from one bundle of wiring lines connected to the common connection target on the vehicle body side, and
the second wiring line is the other wiring line branched from the one bundle of wiring lines on the vehicle body side.

3. The wire harness routing structure according to claim 1, wherein
in the first wiring line, a line length connecting the first vehicle body-side connection target and the first door-side connection target along the first link arm is shorter than a length of a path connecting the first vehicle body-side connection target and the first door-side connection target via the second link arm, and
in the second wiring line, a line length connecting the second vehicle body-side connection target and the second door-side connection target along the second link arm is shorter than a length of a path connecting the second vehicle body-side connection target and the second door-side connection target via the first link arm.

4. The wire harness routing structure according to claim 2, wherein
in the first wiring line, a line length connecting the first vehicle body-side connection target and the first door-side connection target along the first link arm is shorter than a length of a path connecting the first vehicle body-side connection target and the first door-side connection target via the second link arm, and
in the second wiring line, a line length connecting the second vehicle body-side connection target and the second door-side connection target along the second link arm is shorter than a length of a path connecting the second vehicle body-side connection target and the second door-side connection target via the first link arm.

5. The wire harness routing structure according to claim 1, further comprising:
a drive unit that is provided in the door main body or the first link arm and rotates the first link arm, wherein
the first wiring line includes a power line for supplying power to the drive unit.

6. The wire harness routing structure according to claim 2, further comprising:
a drive unit that is provided in the door main body or the first link arm and rotates the first link arm, wherein
the first wiring line includes a power line for supplying power to the drive unit.

7. The wire harness routing structure according to claim 3, further comprising:
a drive unit that is provided in the door main body or the first link arm and rotates the first link arm, wherein
the first wiring line includes a power line for supplying power to the drive unit.

8. A link type slide door comprising:
a door main body that is assembled to a vehicle body;
a first link arm that has one end rotatably coupled to the vehicle body and the other end rotatably coupled to the door main body and supports the door main body to be slidable with respect to the vehicle body while relatively rotating with respect to each of the vehicle body and the door main body;
a second link arm that is provided side by side with the first link arm along a vertical direction, has one end rotatably coupled to the vehicle body and the other end rotatably coupled to the door main body, and supports the door main body to be slidable with respect to the vehicle body together with the first link arm while relatively rotating with respect to each of the vehicle body and the door main body;
a first wiring line that is provided to be routed along the first link arm and connects a first vehicle body-side connection target on the vehicle body side and a first door-side connection target on the door main body side; and
a second wiring line that is provided to be routed along the second link arm and connects a second vehicle body-side connection target on the vehicle body side and a second door-side connection target on the door main body side.

9. A wire harness comprising:
a first wiring line that has one end rotatably coupled to a vehicle body and the other end rotatably coupled to a door main body assembled to the vehicle body, is provided to be routed along a first link arm that slidably supports the door main body with respect to the vehicle body while relatively rotating with respect to each of the vehicle body and the door main body, connects a first vehicle body-side connection target on the vehicle body side and a first door-side connection target on the door main body side; and
a second wiring line that is provided side by side with the first link arm along a vertical direction, has one end rotatably coupled to the vehicle body and the other end rotatably coupled to the door main body, is provided to be routed along a second link arm that slidably supports the door main body with respect to the vehicle body together with the first link arm while relatively rotating with respect to each of the vehicle body and the door main body, and connects a second vehicle body-side connection target on the vehicle body side and a second door-side connection target on the door main body side.
